(19) United States
(12) Patent Application Publication
(10) Pub. No.: US 2016/0275036 A1
(43) Pub. Date: Sep. 22, 2016

(54) SINGLE BOARD COMPUTER INTERFACE

(71) Applicant: Western Digital Technologies, Inc., Irvine, CA (US)

(72) Inventor: DAVID W. CHEW, SAN JUAN CAPISTRANO, CA (US)

(21) Appl. No.: 14/742,486

(22) Filed: Jun. 17, 2015

Related U.S. Application Data
(60) Provisional application No. 62/135,626, filed on Mar. 19, 2015.

(51) Int. Cl. G06F 13/40; G06F 13/38; G06F 13/42

(52) U.S. Cl. CPC G06F 13/4081; G06F 13/4282; G06F 13/387

(57) ABSTRACT

An adapter or Data Storage Device (DSD) communicates with a Single Board Computer (SBC). SBC interface circuitry of the adapter or DSD is configured to provide power to the SBC and to send data to and receive data from the SBC. In the case of an adapter, an SBC connector of the SBC interface circuitry is configured to physically contact the SBC when the SBC is connected to the adapter through the SBC connector.

### CROSS REFERENCE TO RELATED APPLICATION

This application claims the benefit of U.S. Provisional Application No. 62/135,626 (Atty Docket No. T8113.P) filed on Mar. 19, 2015, and entitled “DATA STORAGE DEVICE ADAPTER WITH INTEGRATION FOR MINIATURE COMPUTE DEVICE” by David W. Chew, which is hereby incorporated by reference in its entirety.

### BACKGROUND

Single Board Computers (SBCs) can include all of the processing and memory functions of a full sized computer on a single Printed Circuit Board (PCB). In addition to having a smaller size than traditional computers such as a laptop or desktop computer, SBCs are also typically less expensive. Examples of recent SBCs include the Raspberry Pi module, the Intel Edison module, the Intel Galileo module, and the Arduino module.

SBCs also generally have less power or current to provide to peripheral devices than a traditional computer can provide. Peripheral devices such as a Data Storage Device (DSD) often must use additional power cables, sometimes in combination with a powered hub, to be used with an SBC. These cables and components can increase the overall footprint of the system and can make such setups impractical for uses where space is limited or where a compact design is desired.

### BRIEF DESCRIPTION OF THE DRAWINGS

The features and advantages of the embodiments of the present disclosure will become more apparent from the detailed description set forth below when taken in conjunction with the drawings. The drawings and the associated descriptions are provided to illustrate embodiments of the disclosure and not to limit the scope of what is claimed.

FIG. 1 is a block diagram depicting a system including a Single Board Computer (SBC), an adapter, and a Data Storage Device (DSD) according to an embodiment.

FIG. 2 is a block diagram depicting an adapter for connecting to an SBC according to an embodiment.

FIG. 3 is a block diagram depicting a DSD for connecting to an SBC according to an embodiment.

FIG. 4 illustrates an adapter for connecting to an SBC according to another embodiment.

FIG. 5 illustrates the connection of an adapter to a DSD and SBC according to an embodiment where the DSD is in a tailgate configuration.

FIG. 6 illustrates the adapter, DSD and SBC of FIG. 5 housed within an enclosure according to an embodiment.

FIG. 7 illustrates a stacked configuration of a DSD, adapter, and SBC according to an embodiment where the SBC is substantially parallel to the adapter.

FIG. 8 illustrates a stacked configuration of a DSD, adapter, and SBC according to an embodiment where the SBC is substantially perpendicular to the adapter.

FIG. 9 illustrates a stick device including an adapter connected to an SBC according to an embodiment.

FIG. 10 illustrates the stick device of FIG. 9 with its cover attached according to an embodiment.

### DETAILED DESCRIPTION

In the following detailed description, numerous specific details are set forth to provide a full understanding of the present disclosure. It will be apparent, however, to one of ordinary skill in the art that the various embodiments disclosed may be practiced without some of these specific details. In other instances, well-known structures and techniques have not been shown in detail to avoid unnecessarily obscuring the various embodiments.

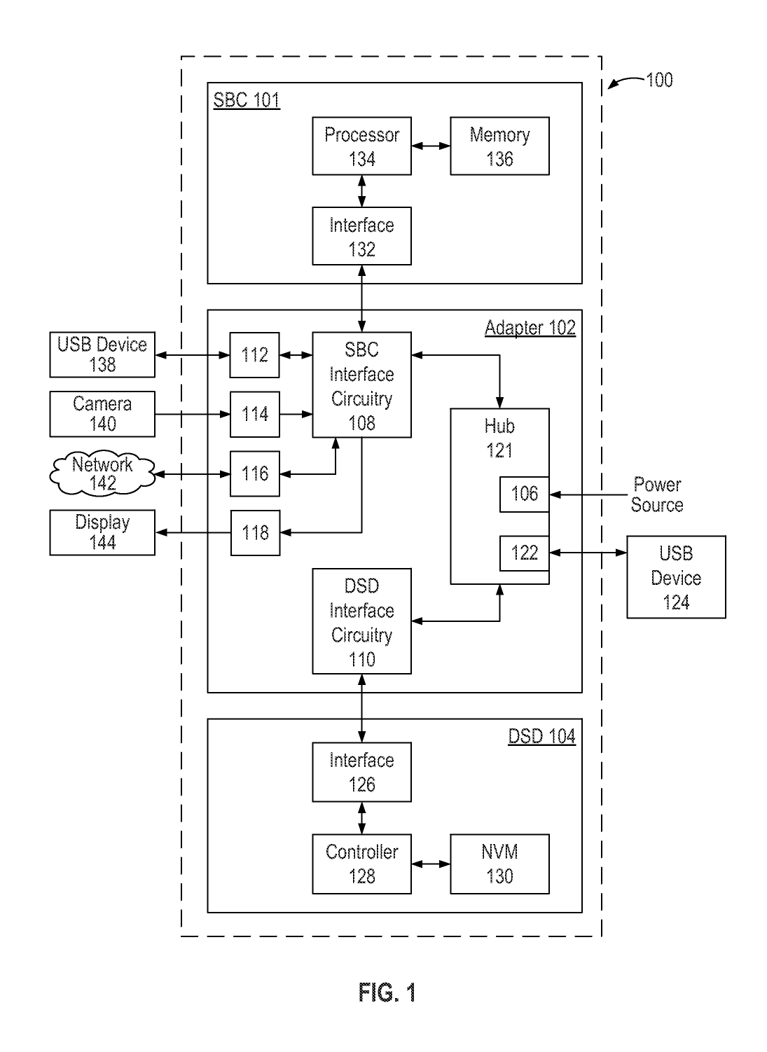

FIG. 1 is a block diagram depicting system 100 including Single Board Computer (SBC) 101, adapter 102, and Data Storage Device (DSD) 104 according to an embodiment. System 100 can include, for example, a computer system such as a laptop or notebook or another type of electronic device such as a tablet, smartphone, network media player, portable media player, or Digital Video Recorder (DVR). In some implementations, the components of system 100 can be housed within a single enclosure to form one electronic device. In other implementations, only SBC 101 and adapter 102 are housed in one enclosure with DSD 104 serving as a peripheral device of system 100.

SBC 101 can include, for example, miniature or small compute devices such as a Raspberry Pi module (e.g., Raspberry Pi, Raspberry Pi Compute Module), an Intel Edison module, an Intel Galileo module, or an Arduino module. Such devices can include processing and memory functions on a single Printed Circuit Board (PCB). In addition to having a smaller size than traditional computers such as a desktop computer, SBCs are also usually less expensive. As noted above, SBCs generally have a limited amount of power or current available for other devices such as a DSD. In order to be used with an SBC, some peripheral devices have conventionally required separate power cables or external powered hubs in addition to data cables. According to one aspect, the present disclosure involves providing power for an SBC and its connected devices while maintaining a compact design.

In the example of FIG. 1, SBC 101 includes processor 134, memory 136, and interface 132. Processor 134 can include circuitry such as one or more processors for executing instructions and can include a microcontroller, a Digital Signal Processor (DSP), an Application Specific Integrated Circuit (ASIC), a Field Programmable Gate Array (FPGA), hard-wired logic, analog circuitry and/or a combination thereof.

Memory 136 can include, for example, a Dynamic Random Access Memory (DRAM) or other type of memory used to store computer-executable instructions for execution by processor 134. Memory 136 may also store data used by processor 134 in executing computer executable instructions. In one embodiment, processor 134 and memory 136 may be combined as a system on a chip (SoC).

Interface 132 allows processor 134 to communicate with adapter 102 via SBC interface circuitry 108 and to receive power from SBC interface circuitry 108. In one implementation, interface 132 can include a connector such as Small Outline Dual In-Line Memory Module (SO-DIMM) pins that connect into a SO-DIMM socket of SBC interface circuitry 108 of adapter 102. Other implementations may use different card connectors such as a Hirose 40 or 70 pin connector for example.

SBC interface circuitry 108 provides power to SBC 101 and allows adapter 102 to send data to and receive data from SBC 101 for interfacing between SBC 101 and DSD 104. By powering SBC 101 with adapter 102, the number of external power cables needed to power system 100 can be reduced.

In addition, SBC interface circuitry 108 includes an SBC connector (not shown) configured to physically contact SBC 101 when SBC 101 is connected to adapter 102. As discussed in more detail below, such physical contact between SBC 101 and adapter 102 can ordinarily allow for a more compact arrangement of system 100 without the need for cables. In one implementation, SBC interface circuitry 108 includes an SBC connector such as a SO-DIMM or Hirose socket that receives or contacts pins of interface 132 of SBC 301. Other implementations may use different SBC connections.

SBC interface circuitry 108 is electrically connected to hub 121 which includes power input 106 for receiving power from a power source. Hub 121 also includes USB interface 122 for connecting to a device such as USB device 124.

In some implementations, power input 106 can include, for example, a micro, mini, or standard Universal Serial Bus (USB) interface that receives power from an Alternating Current (AC) adapter that can be plugged into a wall power outlet. Other implementations can include a different type of power input such as a Direct Current (DC) power input or an AC power input. In yet other embodiments, hub 121 may be replaced by a power supply that may include a transformer, rectifier, regulator and/or one or more filters. In still other embodiments, hub 121 may be replaced by or include one or more power storage components such as a battery or capacitor.

Power input 106 is also connected through hub 121 to DSD interface circuitry 110, which is configured to provide power from power input 106 to DSD 104. This allows for a further reduction in external power cables since adapter 102 can ordinarily be used to power both SBC 101 and DSD 104.

DSD interface circuitry 110 is also configured to send data to and receive data from DSD 104, which includes Non-Volatile Memory (NVM) 130 for storing data. In this regard, DSD 104 can include a Hard Disk Drive (HDD), a Solid-State Drive (SSD), a Solid-State Hybrid Drive (SSHD), an optical disc drive, a tape drive, a storage cassette, a storage cartridge, or a different type of DSD.

In some implementations, DSD interface circuitry 110 can include a DSD connector configured to physically contact DSD 104 when DSD 104 is connected to adapter 102. DSD interface circuitry 110 may interface with DSD 104 and power DSD 104 according to a standard such as, for example, Serial Advanced Technology Attachment (SATA) standard. In other implementations, DSD interface circuitry 110 can interface with DSD 104 and power DSD 104 in accordance with other standards such as, for example, PCI express (PCIe) or Serial Attached SCSI (SAS).

Adapter 102 also includes Input/Output (I/O) interfaces 112, 114, 116, and 118. As shown in FIG. 1, each of these I/O interfaces is electrically connected to SBC interface circuitry 108 to send data to and/or receive data from SBC interface circuitry 108 for communicating with SBC 101. In addition, each of these I/O interfaces can be powered as needed by power input 106 via SBC interface circuitry 108 and thereby reduce the need for additional power cables that may otherwise be needed if using I/O interfaces of SBC 101 without adapter 102.

USB device 138 is connected to adapter 102 via I/O interface 112 and can include, for example, a Bluetooth or WiFi dongle to allow system 100 to communicate on a wireless network. In other examples, USB device 138 can include an input device such as a keyboard or mouse for interfacing with SBC 101 or DSD 104 or another device that can allow for programming of SBC 101 (e.g., flash programming).

In one implementation, camera 140 can include a video or single image camera connected to a Zero Insertion Force (ZIF) connector of camera interface 114. I/O interface 116 can include an Ethernet interface to allow system 100 to communicate on network 142, which can include a Local Area Network (LAN), Wide Area Network (WAN), or the Internet.

Display 144 can include a Liquid Crystal Display (LCD) or other type of display device such as video monitor. In this regard, I/O interface 118 can include, for example, a GPIO or a High Definition Multimedia Interface (HDMI).

DSD 104 communicates with adapter 102 using interface 126, which may interface with adapter 102 according to a standard such as, for example, the SATA standard. In other implementations, interface 126 can interface with adapter 102 using other standards such as, for example, PCIe or SAS. DSD 104 also includes controller 128 for controlling the operation of DSD 104 and NVM 130 for non-volatilely storing data across power cycles.

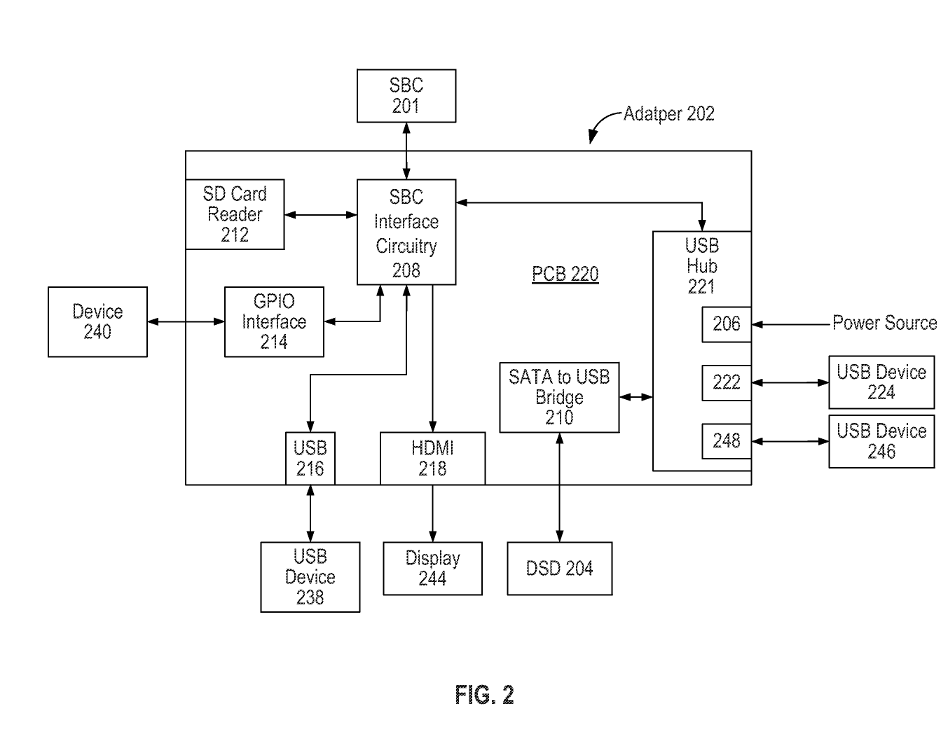

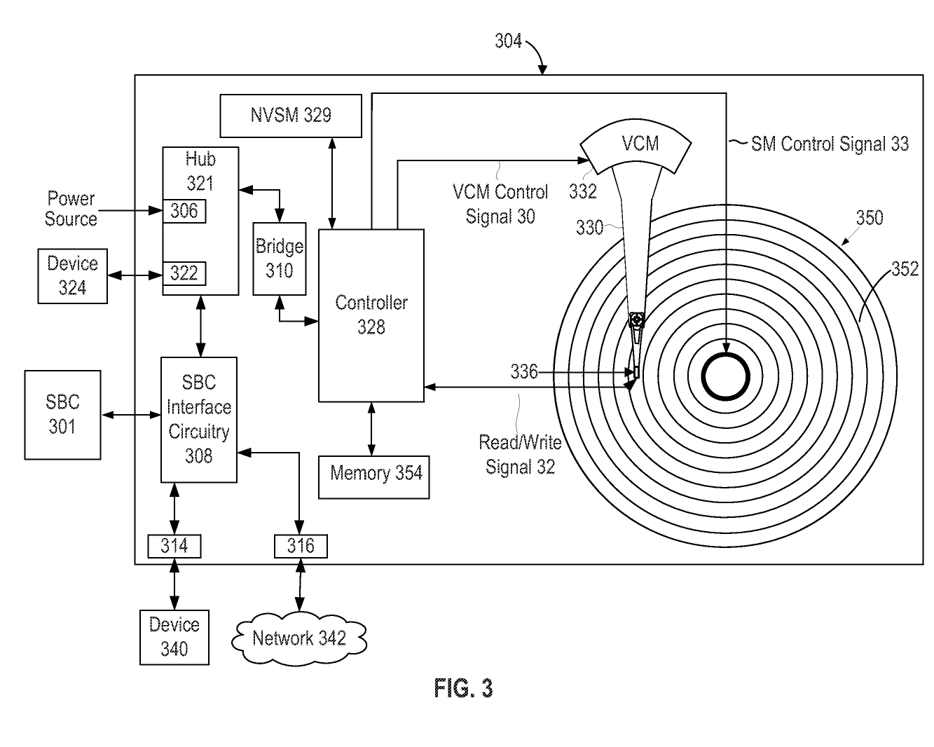

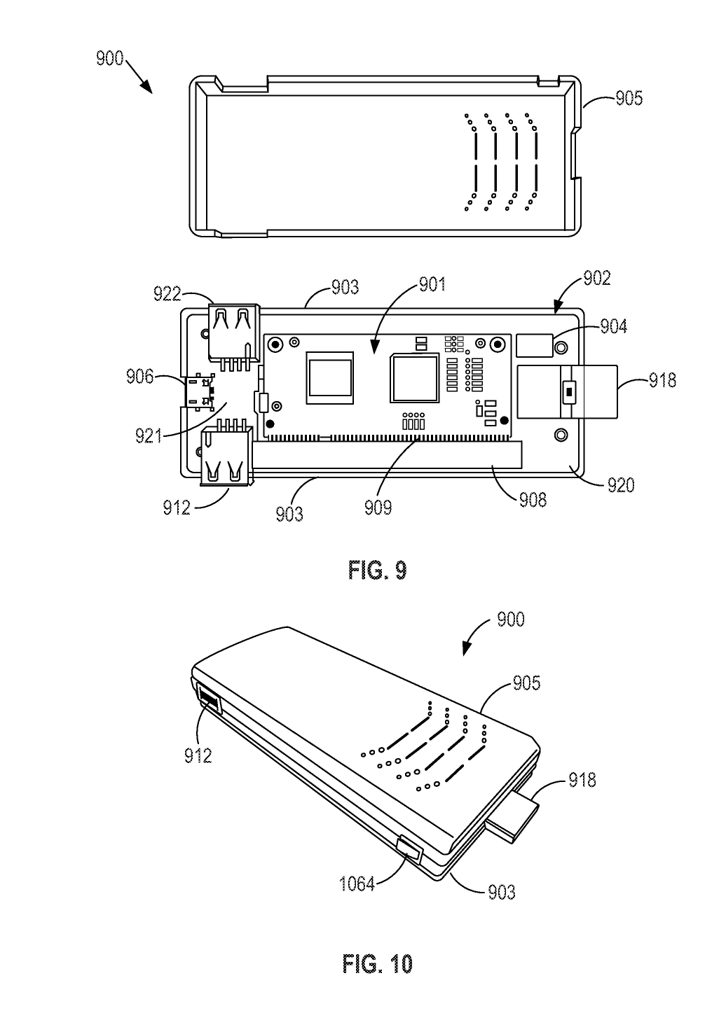

Those of ordinary skill in the art will appreciate that other embodiments of system 100 can include more or less than the components shown in FIG. 1. For example, FIG. 3 discussed below provides an example embodiment where some of the components of adapter 102 are included within a DSD and FIGS. 9 and 10 illustrate an example embodiment where an adapter and SBC are provided without a DSD separate from the SBC. In addition, FIGS. 2, 4, and 5 provide different examples of adapters with various configurations of I/O interfaces.

FIG. 2 is a block diagram depicting adapter 202 according to an embodiment. As shown in FIG. 2, adapter 202 includes components on PCB 220 including SBC interface circuitry 208 for interfacing and powering SBC 201. SBC interface circuitry 208 provides power to SBC 201 and allows adapter 202 to send data to and receive data from SBC 201 for interfacing between SBC 201 and DSD 204. In addition, SBC interface circuitry 208 includes an SBC connector configured to physically contact SBC 201 when SBC 201 is connected to adapter 202. Such physical contact between SBC 201 and adapter 202 can ordinarily allow for a more compact arrangement of SBC 201 and adapter 202. In one implementation, SBC interface circuitry 208 includes an SBC connector such as a SO-DIMM or Hirose socket that receives or contacts pins of a connector of SBC 201. Other implementations may use different SBC connections.

SBC interface circuitry 208 is electrically connected to USB hub 221 which includes power input 206 for receiving power from a power source. By powering SBC 201 via adapter 202, the number of external power cables can be consolidated. Hub 221 also includes USB interfaces 222 and 248 for connecting USB devices 224 and 246, respectively.

In some implementations, power input 206 can include, for example, a micro, mini, or standard USB connector. In such implementations, power input 206 may supply USB hub 221 with a 5 Volt DC power with 2.5 or 3.0 amps to be shared among SBC 201, DSD 204, and other devices connected to adapter 202 through I/O interfaces.

Other implementations can include a different type of power input such as a DC power input or an AC power input. In other embodiments, USB hub 221 may be replaced by a power supply that may include a transformer, rectifier, regulator and/or one or more filters. In still other embodiments, USB hub 221 may be replaced by or include one or more power storage components such as a battery or capacitor.

Power input 206 is also connected through USB hub 221 to SATA to USB bridge 210, which serves as DSD interface circuitry that converts between a USB standard and the SATA standard to send data to and receive data from DSD 204. By powering both SBC 201 and DSD 204 using adapter 202, it is ordinarily possible to further reduce the number of external power cables needed to power a system including SBC 201 and DSD 204.

The data sent to DSD 204 or received from DSD 204 can be routed to SBC interface circuitry 208 by USB hub 221 for communication with SBC 201 which can request or send the data. As in the example of FIG. 2, DSD 204 can include various types of DSDs including, for example, an HDD, an SSD, an SSHD, an optical disc drive, a tape drive, a storage cassette, a storage cartridge.

SATA to USB bridge 210 further includes a SATA connector (not shown) that is configured to physically contact DSD 204 when DSD 204 is connected to adapter 202. Although the SATA standard is used in the example of FIG. 2, other standards may be used in a bridge connected to USB hub 221 for other embodiments. In addition, SATA to USB bridge 210 can include a Light Emitting Diode (LED) to indicate activity of DSD 204 such as when data is sent to or received from DSD 204.

Adapter 202 also includes several I/O interfaces that are electrically connected to SBC interface circuitry 208 for providing data to SBC 201 or receiving data from SBC 201. In addition, each of the I/O interfaces can be powered as needed by power input 206 via SBC interface circuitry 208 to reduce the need for additional power cables that may otherwise be needed if using I/O interfaces of SBC 201 without adapter 202.

As shown in the example of FIG. 2, adapter 202 includes Secure Digital (SD) card reader 212 for receiving an SD memory card. Other implementations may use a different type of memory card reader rather than an SD card reader.

Adapter 202 also includes GPIO interface 214 for interfacing with device 240 which may include a sensor, USB interface 216 for interfacing with USB device 238, and HDMI 218 for interfacing with display 244. Along the lines noted above for adapter 102 of FIG. 1, other embodiments of adapter 202 in FIG. 2 can include different quantities or different types of I/O interfaces than those shown in FIG. 2.

FIG. 3 depicts a block diagram of DSD 304 according to an embodiment. The arrangement of FIG. 3 differs from that of FIG. 1 in that many of the components of adapter 102 are located within DSD 304. For example, DSD 304 in FIG. 3 includes hub 321, bridge 310, and SBC interface circuitry 308.

SBC interface circuitry 308 is electrically connected to power input 306 and provides power from power input 306 to SBC 301. In addition, SBC interface circuitry 308 allows DSD 304 to send data to and receive data from SBC 301 for interfacing between SBC 301 and DSD 304. SBC interface circuitry 308 can include an SBC connector (not shown) configured to physically contact SBC 301 when SBC 301 is connected to DSD 304. Such physical contact between SBC 301 and DSD 304 can ordinarily allow for a more compact arrangement of SBC 301 and DSD 304. In some implementations, SBC interface circuitry 308 can include an SBC connector such as a SO-DIMM or Hirose socket that receives pins of SBC 301. Other implementations may use different SBC connections.

In addition to power input 306, hub 321 includes I/O interface 322 for connecting a device to DSD 304. In some examples, I/O interface 322 can include a USB interface that allows for connection of a Bluetooth or WiFi dongle as device 324 to allow SBC 301 or DSD 304 to communicate on a wireless network. In other examples, device 324 can include an input device such as a keyboard or mouse for interfacing with SBC 301 or DSD 304, or another device for programming SBC 301 or controller 328 of DSD 304.

Power input 306 can include, for example, a micro, mini, or standard USB connector that receives power from an AC adapter. Other implementations can include a different type of power input such as a DC power input or an AC power input. In other embodiments, hub 321 may be replaced by a power supply that may include a transformer, rectifier, regulator and/or one or more filters. In still other embodiments, hub 321 may be replaced by or include one or more power storage components such as a battery or capacitor.

As shown in FIG. 3, hub 321 is also connected to controller 328 via bridge 310, which can convert between a standard used by hub 321 (e.g., a USB standard) and a standard used by controller 328 (e.g., a SATA standard). Bridge 310 allows controller 328 to send data to and receive data from interfaces such as 322, 314, 316, and SBC interface circuitry 308.

In this regard, DSD 304 includes I/O interfaces 314 and 316 that are electrically connected to SBC interface circuitry 308 for providing data to SBC 301 or receiving data from SBC 301. I/O interface 314 is configured to interface with device 340. In addition, I/O interface 314 can be powered as needed by power input 306 via SBC interface circuitry 308 to reduce the need for an additional power cable to power device 340. I/O interface 316 is configured to interface with network 342 and may include, for example, a WiFi interface, Bluetooth interface, or an Ethernet interface that is built into DSD 304.

As shown in the example of FIG. 3, DSD 304 includes NVM in the form of rotating magnetic disk 350 and Non-Volatile Solid-State Memory (NVSM) 328. In this regard, DSD 304 can be considered an SSHD since it includes both a disk NVM and solid-state NVM. In other embodiments, DSD 304 may not include one of NVSM 329 or disk 350, or may include a different type of NVM altogether. In addition, each of NVSM 329 and/or disk 350 may be replaced by multiple SSDs or HDDs in other embodiments.

DSD 304 includes controller 328 which includes circuitry such as one or more processors for executing instructions and can include a microcontroller, a DSP, an ASIC, an FPGA, hard-wired logic, analog circuitry and/or a combination thereof. In one implementation, controller 328 can include an SoC.

SBC interface circuitry 308 is configured to interface DSD 304 with SBC 301 and may interface according to a standard such as, for example, SATA, PCIe, SCSI, or SAS.

In the example of FIG. 3, disk 350 is rotated by a spindle motor (not shown) and head 336 is positioned to read and write data on the surface of disk 350. In more detail, head 336 is connected to the distal end of actuator 330 which is rotated by Voice Coil Motor (VCM) 332 to position head 336 over disk 350 to read or write data in tracks 352 on disk 350. As will be appreciated by those of ordinary skill in the art, some embodiments may include one or more additional disks circumferentially aligned below disk 350 to form a disk pack with corresponding heads 336 arranged in a Head Stack Assembly (HSA) to read and write data on corresponding disk surfaces of the disk pack.

DSD 304 also includes NVSM 329 for storing data across power cycles. While the description herein refers to solid-state memory generally, it is understood that solid-state memory may comprise one or more of various types of memory devices such as flash integrated circuits, Chalcogenide RAM (C-RAM), Phase Change Memory (PC-RAM or PRAM), Programmable Metallization Cell RAM (PMC-RAM or PMCm), Ovonic Unified Memory (OUM), Resistive RAM (RRAM), NAND memory (e.g., single-level cell (SLC) memory, multi-level cell (MLC) memory, or any combination thereof), NOR memory, EEPROM, Ferroelectric Memory (FeRAM), Magnetoresistive RAM (MRAM), other discrete NVM (non-volatile memory) chips, or any combination thereof.

As shown in FIG. 3, DSD 304 includes memory 354, which can include, for example, DRAM that is used by DSD 304 to temporarily store data. Data stored in memory 354 can include data read from NVM such as disk 350 or NVSM 329, data to be stored in NVM, instructions loaded from a firmware of DSD 304 for execution by controller 328, and/or data used in executing firmware. In this regard, the firmware of DSD 304 can include computer executable instructions for controlling operation of DSD 304.

In operation, controller 328 receives read and write commands from SBC 301 via SBC interface circuitry 308, hub 321 and bridge 310. In response to a write command from SBC 301, controller 328 may buffer the data to be written for the write commands in memory 354.

For data to be written on disk 350, a read/write channel (not shown) of controller 328 may encode the buffered data into write signal 32 which is provided to head 336 for magnetically writing data on disk 350. In addition, controller 328 via a servo system (not shown) can provide VCM control signal 30 to VCM 332 to position head 336 over a particular track for writing the data.

In response to a read command for data stored on disk 350, controller 328 via a servo system positions head 336 over a particular track. Controller 328 controls head 336 to magnetically read data stored in the track and to send the read data as read signal 32. A read/write channel of controller 328 can then decode and buffer the data into memory 354 for transmission to SBC 301 via bridge 310, hub 321, and SBC interface circuitry 308.

For data to be stored in NVSM 329, controller 328 receives data from bridge 310 and may buffer the data in memory 354. In one implementation, the data is then encoded into charge values for charging cells (not shown) of NVSM 329 to store the data.

In response to a read command for data stored in NVSM 329, controller 328 in one implementation reads current values for cells in NVSM 329 and decodes the current values into data that can be transferred to SBC 301 via bridge 310, hub 321 and SBC interface circuitry 308.

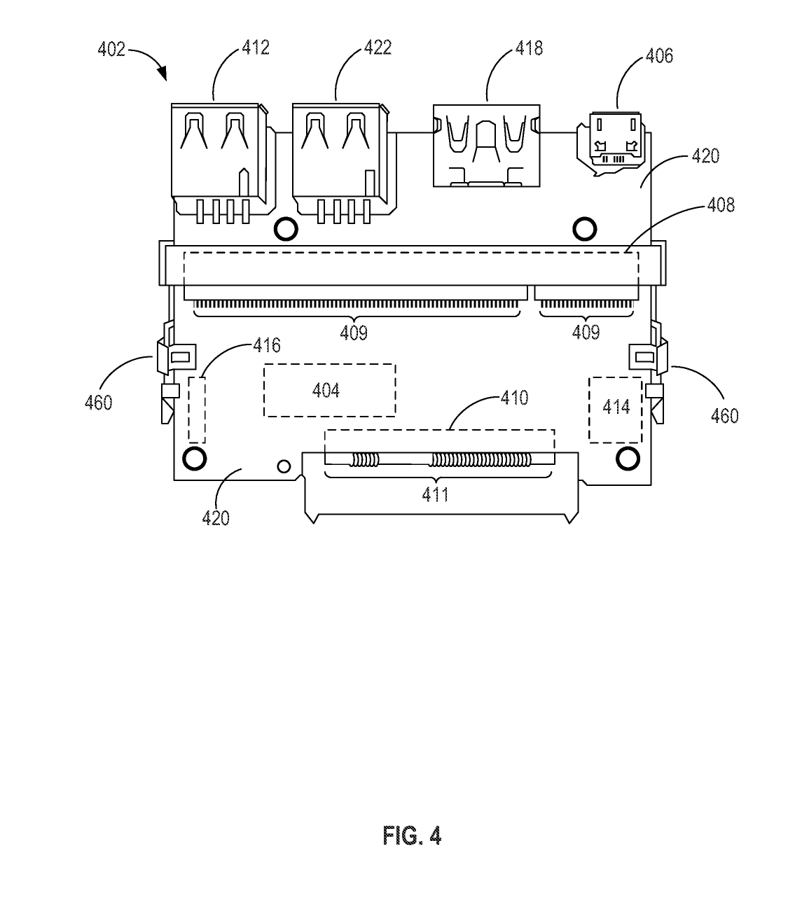

FIG. 4 illustrates an example of adapter 402 according to an embodiment. As shown in FIG. 4, adapter 402 includes power input 406 as a micro-USB interface, HDMI 418, and standard USB interfaces 412 and 422. Each of these interfaces is mounted on a top side of PCB 420. In addition, SBC connector 409 is shown as a SO-DIMM socket on PCB 420. SBC interface circuitry 408 is provided beneath SBC connector 409.

Clips 460 are located on opposite edge portions of PCB 420 to secure an SBC when connected to adapter 402 through SBC connector 409. The configuration of adapter 402 allows for an SBC to be located above or below PCB 420 when the SBC is connected to adapter 402 through SBC connector 409. This arrangement can also allow for the SBC to fit within a footprint or area of PCB 420 to save space and provide a more compact design for a system including adapter 402 and the SBC.

Adapter 402 also includes DSD connector 411, which is shown in the example of FIG. 4 as a SATA connector. DSD interface circuitry 410 is provided beneath DSD connector 411. In FIG. 4, DSD connector 411 is positioned on PCB 420 so that a DSD is located horizontally adjacent PCB 402 on one end portion of adapter 402 when the DSD is connected to adapter 402 through DSD connector 411. As shown in FIG. 4, I/O interfaces 412, 422, 418, and power input 406 are located on an opposite end portion of adapter 402.

On a bottom surface of PCB 420, adapter 402 includes GPIO interface 416 and SD card reader 414. Adapter 402 in other embodiments can include a different layout of components such that power input 406, HDMI 418, USB interfaces 412 and 422, SBC connector 409, DSD connector 411, GPIO interface 416, or SD card reader 414 are located on different sides of PCB 420 or on a different portion of PCB 420 than those shown in FIG. 4. For example, power input 406 or various I/O interfaces may be at an orthogonal edge of PCB 420 relative to DSD connector 411, rather than at the opposite end portion of PCB 420 as shown.

In addition, other embodiments may include more or less components than those shown in FIG. 4 or different components than those shown in FIG. 4. In this regard, adapter 402 may also include its own non-volatile memory. For example, location 404 on PCB 420 can include a non-volatile solid-state memory such as a flash memory. In such embodiments, adapter 402 may or may not include DSD interface circuitry 410 and DSD connector 411 since adapter 402 can provide non-volatile data storage in place of a DSD.

In this regard, different combinations of I/O interfaces can be used based on a target application. The example of adapter 402 in FIG. 4 can be for use as a media player with HDMI 418 to connect to a display device and USB interfaces 412 and 422 being available to connect to a WiFi or Bluetooth dongle for access to a wireless network. Adapter 402 may also include an analog audio jack for such a media player implementation.

In another example where adapter 402 is to be used for a surveillance application, adapter 402 may include a connector such as a ZIF connector for connecting to a video camera.

### Example DSD Tailgate Configuration

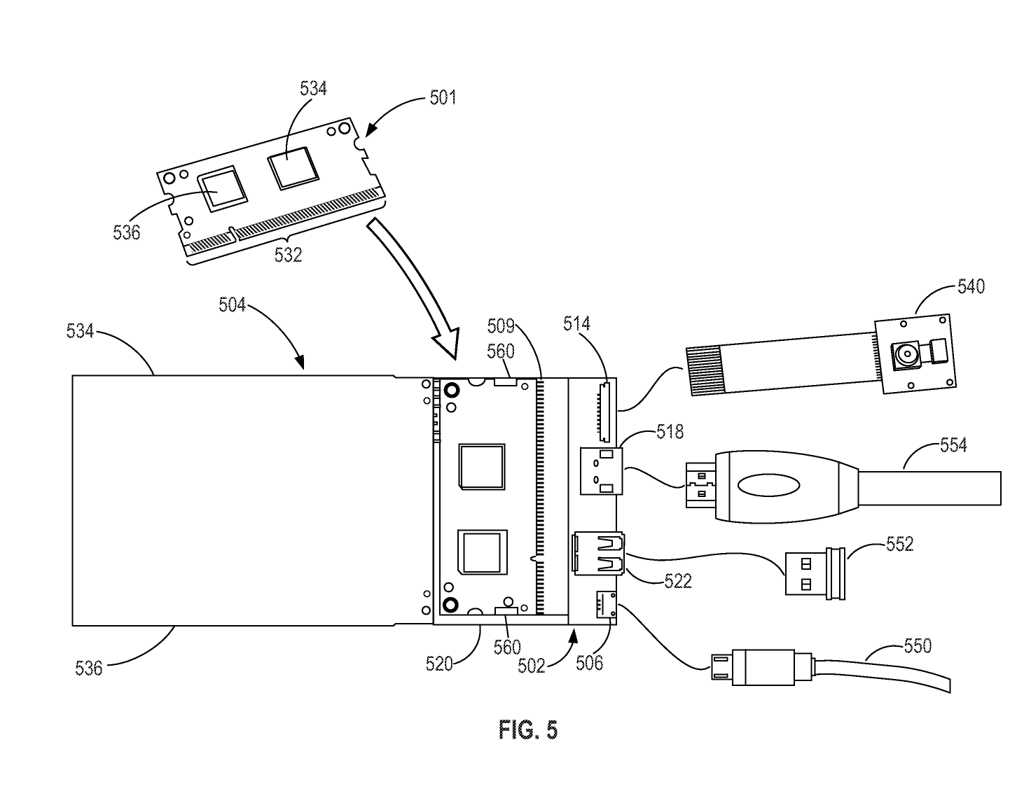

FIG. 5 illustrates the connection of adapter 502 to DSD 504 and SBC 501 according to an embodiment where DSD 504 is in a tailgate configuration with respect to adapter 502. As shown in FIG. 5, DSD 504 is in physical contact with adapter 502 with a DSD connector of the DSD interface circuitry of adapter 502 in physical contact with DSD 504. As noted above, this can allow for a more compact system or overall device that includes DSD 504, adapter 502, and SBC 501.

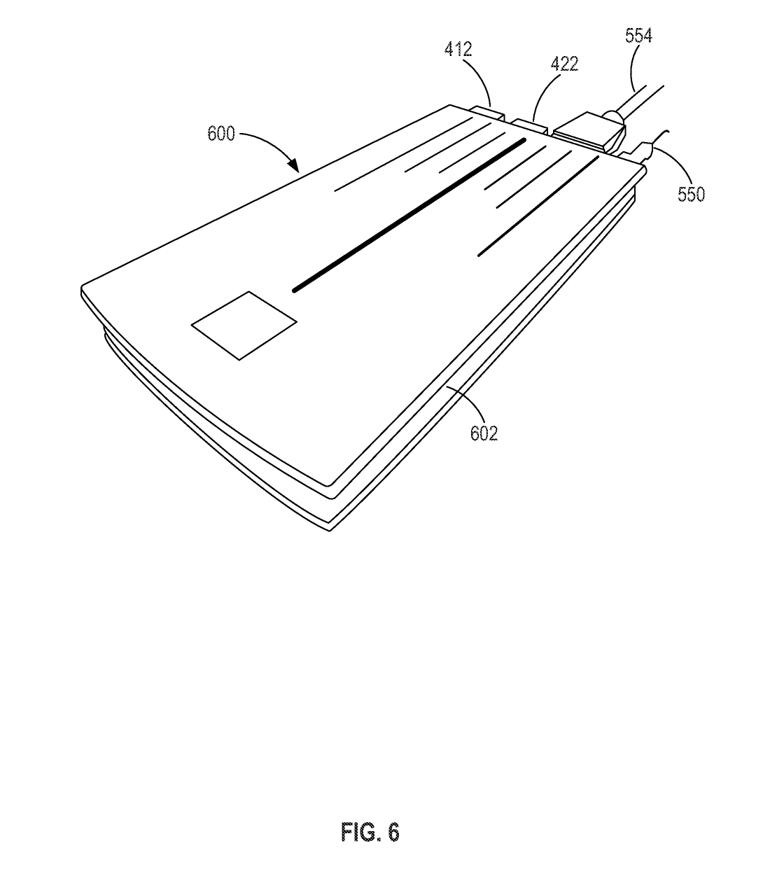

In the example of FIG. 5, DSD 504 is located horizontally adjacent adapter 502 and the DSD connector of adapter 502 is configured so that the outside edges of adapter 502 are within a corresponding pair of outside edges 534 and 536 of DSD 504. In other embodiments, the outside edges of adapter 502 can be flush with edges 534 and 536 of DSD 504. This can allow for space savings and improved manufacturability when DSD 504, adapter 502, and SBC 501 are housed within an enclosure as shown in FIG. 6.

In some embodiments, the top and bottom surfaces of adapter 502 may also be within a pair of corresponding top and bottom surfaces of DSD 504. For example, a top surface of SBC connector 509 and a component on the bottom surface of PCB 520 may be within the top and bottom surfaces of DSD 504 to further improve space savings and manufacturability when DSD 504, adapter 502, and SBC 501 are housed together within an enclosure.

As shown in FIG. 5, SBC 501 includes processor 534 and memory 536. Interface 532 of SBC 501 includes pins that connect with SBC connector 509 of adapter 502. SBC 501 can be inserted into SBC connector 509 and secured in place with clips 560.

Adapter 502 also includes GPIO interface 514, USB interfaces 518 and 522, and power input 506. GPIO interface 514 can connect to, for example, sensors for providing data to SBC 501 or an LCD to display information. USB interface 518 can connect to USB cable 554 which allows for communication between SBC 501 and a peripheral device such as a printer, keyboard, mouse, or smartphone. USB interface 522 can connect to USB device 552, which can include, for example, a Bluetooth or WiFi dongle to allow SBC 501 to communicate on a wireless network via adapter 502.

Power input 506 can include, for example, a mini or micro USB interface for receiving power from a USB power adapter (not shown) connected to cable 550. Power input 506 can provide power to adapter 502, SBC 501, and DSD 504. As noted above, the amount of cables needed to power a system including an adapter, DSD, and SBC can ordinarily be reduced or consolidated into one power cable with a power input on an adapter as disclosed herein. Since SBCs often cannot reliably provide enough power or current for certain devices such as a DSD, the adapters of the present disclosure can provide more reliable power for such devices in addition to providing power to the SBC.

In FIG. 6, DSD 504, SBC 501, and adapter 502 are housed within enclosure 602 to form device 600 according to an embodiment. By using the interconnection of DSD 504, SBC 501, and adapter 502 shown in FIG. 5, these components can fit within a more compact enclosure 602. The size of the enclosure of devices such as device 600 can impact the device's overall appeal, usefulness, and cost of manufacture.

### Stacked Configuration Examples

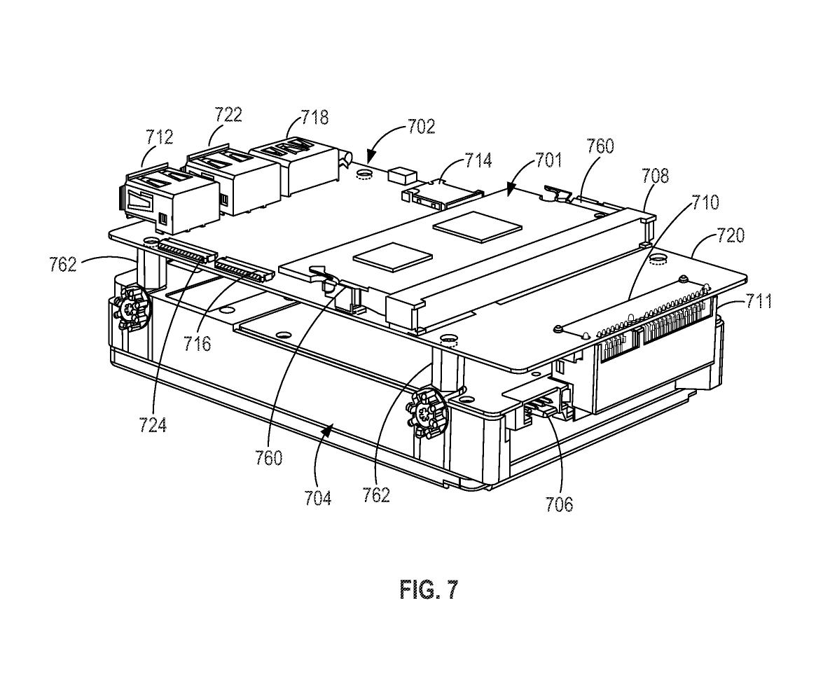

FIG. 7 illustrates a stacked configuration of DSD 704, adapter 702, and SBC 701 according to an embodiment where SBC 701 is substantially parallel to adapter 702. Although the stacked configuration shown in FIG. 7 may result in a taller overall height than the tailgate configuration of FIGS. 5 and 6, the stacked configuration of FIG. 7 can maintain a particular horizontal footprint such as an existing footprint of DSD 704.

In the example of FIG. 7, SBC 701 and DSD 704 are located on opposite sides of PCB 720 of adapter 702. SBC interface circuitry 708 physically contacts SBC 701 and clips 760 secure SBC 701 into place to reduce movement of SBC 701 relative to an SBC connector of SBC interface circuitry 708. Adapter 702 also includes USB interfaces 712 and 722 and HDMI 718. In addition, adapter 702 includes ZIF connectors 716 and 724 and memory card reader 714.

Adapter 702 connects to DSD 704 via DSD interface circuitry 710 that includes DSD connector 711 which can be implemented with a right angled SATA connector as shown in FIG. 7. In other implementations, a flexible DSD connector such as a ribbon cable may be used to connect adapter 702 and DSD 704.

In FIG. 7, adapter 702 is mounted on DSD 704 using supports 762. In addition, the example of FIG. 7 differs from the example of FIG. 5 in that power input 706 is part of DSD 704 rather than adapter 702. Power input 706 can be, for example, a DC power input that supplies power to DSD 704, adapter 702, and SBC 701. The power supplied to adapter 702 and SBC 701 can be provided from DSD 704 to adapter 702 through DSD connector 711 and then on to SBC 701 through SBC interface circuitry 708. Although DSD 704 receives power from an external power cable, the arrangement of FIG. 7 still allows for a reduced number of power cables when compared to powering SBC 701 without the use of adapter 702.

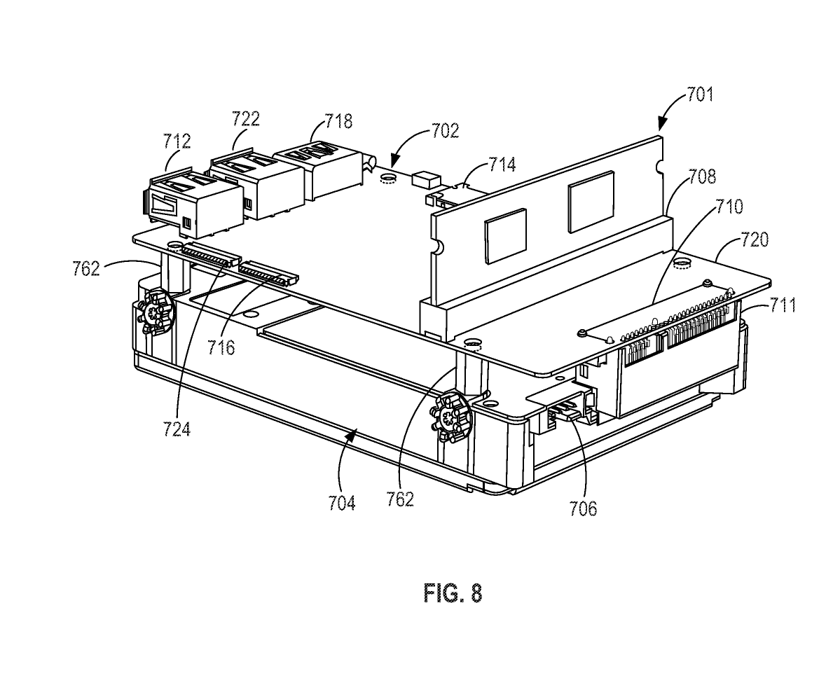

FIG. 8 illustrates a stacked configuration of DSD 704, adapter 702, and SBC 701 according to an embodiment where SBC 701 is substantially perpendicular to adapter 702. As shown in FIG. 8, SBC interface circuitry 708 is orientated so that the SBC connector holds SBC 701 vertically. Clips 706 have been removed from the example of FIG. 8, but other clips or supports may be used to hold SBC 701 in the position shown in FIG. 8.

Although FIG. 8 depicts SBC 701 in a substantially perpendicular position to adapter 702, the SBC connector could be arranged at a different angle so that SBC 701 is orientated at a different angle with respect to adapter 702 in other embodiments.

In addition, adapter 702 in other embodiments may be at an angle with respect to DSD 704 rather than being in the substantially parallel orientation shown in FIGS. 7 and 8. For example, DSD connector 711 and adapter 702 can be configured in other embodiments such that adapter 702 is substantially perpendicular to the top and bottom surfaces of DSD 704 when connected to DSD 704.

### Example Stick Configuration

FIG. 9 illustrates stick device 900 with top cover 905 removed from bottom cover 903 to show adapter 902 connected to SBC 901 according to an embodiment. HDMI 918 of adapter 902 can be used to plug device 900 into another device that has an HDMI port such as a television. In such an implementation, stick device 900 may be used for streaming data to the television.

As shown in FIG. 9, device 900 does not include a DSD separate from adapter 902 as in the examples discussed above. Instead, adapter 902 includes solid-state memory 904 (e.g., flash memory) for non-volatilely storing data. Other embodiments of stick device 900 may not include a solid-state memory for non-volatilely storing data.

Adapter 902 includes SBC interface circuitry 908 with SBC connector 909 for powering and interfacing with SBC 901. In addition, adapter 902 includes power input 906 of USB hub 921 for receiving power from a power source. Power input 906 can include, for example, a micro or mini USB interface. In one example, HDMI 918 can connect to an HDMI port of a television and power input 906 or one of USB interfaces 912 or 922 can connect to a USB port of the television for power. In addition, future versions of HDMI may provide power so that device 900 can be powered through HDMI 918.

USB interfaces 912 and 922 of adapter 902 can also allow for connecting to devices such as a flash memory stick, a smartphone or other computer, or a Bluetooth or WiFi dongle for connecting to a wireless network. The USB interface can also allow for programming of SBC 901. In some embodiments, adapter 902 may also include an interface for connecting to a wireless network with Bluetooth or WiFi circuitry embedded on adapter 902 so that connection to an external device is not needed to connect to a wireless network.

FIG. 10 illustrates device 900 with its top cover 905 attached to bottom cover 903. In the example of FIG. 10, top cover 905 is secured to bottom cover 903 with clasp 1064, which can allow for removal of top cover 905 in order to access adapter 902 or SBC 901. This can ordinarily facilitate replacement of SBC 901 to upgrade or repair device 900.

As with the example embodiments discussed above, the compact configuration of adapter 902 and SBC 901 ordinarily allows for a more aesthetic, useful, and less expensive device than conventional arrangements with an SBC. In addition, the use of adapter 902 can allow for the power input of device 900 to be consolidated for SBC 901, adapter 902, and other devices that may connect to adapter 902.

### Other Embodiments

Those of ordinary skill in the art will appreciate that the various illustrative logical blocks, modules, and processes described in connection with the examples disclosed herein may be implemented as electronic hardware, computer software, or combinations of both. Furthermore, the foregoing processes can be embodied on a computer readable medium which causes a processor or computer to perform or execute certain functions.

To clearly illustrate this interchangeability of hardware and software, various illustrative components, blocks, and modules have been described above generally in terms of their functionality. Whether such functionality is implemented as hardware or software depends upon the particular application and design constraints imposed on the overall system. Those of ordinary skill in the art may implement the described functionality in varying ways for each particular application, but such implementation decisions should not be interpreted as causing a departure from the scope of the present disclosure.

The various illustrative logical blocks, units, modules, and controllers described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The activities of a method or process described in connection with the examples disclosed herein may be embodied directly in hardware, in a software module executed by a processor, or in a combination of the two. The steps of the method or algorithm may also be performed in an alternate order from those provided in the examples. A software module may reside in RAM memory, flash memory, ROM memory, EPROM memory, EEPROM memory, registers, hard disk, a removable media, an optical media, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC).

The foregoing description of the disclosed example embodiments is provided to enable any person of ordinary skill in the art to make or use the embodiments in the present disclosure. Various modifications to these examples will be readily apparent to those of ordinary skill in the art, and the principles disclosed herein may be applied to other examples without departing from the spirit or scope of the present disclosure. The described embodiments are to be considered in all respects only as illustrative and not restrictive and the scope of the disclosure is, therefore, indicated by the following claims rather than by the foregoing description. All changes which come within the meaning and range of equivalency of the claims are to be embraced within their scope.

What is claimed is:

1. An adapter in communication with a Data Storage Device (DSD) and a Single Board Computer (SBC), the adapter comprising:
a Printed Circuit Board (PCB);
a power input on the PCB and configured to receive power from a power source;
DSD interface circuitry on the PCB that is electrically connected to the power input and configured to provide power from the power input to the DSD and to send data to and receive data from the DSD; and
SBC interface circuitry on the PCB that is electrically connected to the power input and configured to provide power from the power input to the SBC and to send data to and receive data from the SBC for interfacing between the DSD and the SBC; and
wherein an SBC connector of the SBC interface circuitry is configured to physically contact the SBC when the SBC is connected to the adapter through the SBC connector.

2. The adapter of claim 1, wherein the SBC connector is further configured so that the SBC is located above or below the PCB when the SBC is connected to the adapter through the SBC connector.

3. The adapter of claim 2, wherein the SBC fits within a footprint of the PCB when the SBC is connected to the adapter through the SBC connector.

4. The adapter of claim 1, wherein a DSD connector of the DSD interface circuitry is configured to physically contact the DSD when the DSD is connected to the adapter through the DSD connector.

5. The adapter of claim 4, wherein the DSD connector is further configured so that the DSD is located horizontally adjacent the PCB when the DSD is connected to the adapter through the DSD connector.

6. The adapter of claim 4, wherein the DSD connector is configured so that at least one opposite pair of outside edges of the adapter is flush or within a corresponding opposite pair of outside edges of the DSD when the DSD is connected to the adapter through the DSD connector.

7. The adapter of claim 4, wherein the DSD connector is configured so that the DSD is located above or below the PCB when the DSD is connected to the adapter through the DSD connector.

8. The adapter of claim 7, wherein the SBC connector is located on a side of the PCB that is opposite the DSD connector.

9. The adapter of claim 1, wherein the SBC connector is further configured so that the SBC is substantially parallel to the PCB when the SBC is connected to the adapter through the SBC connector.

10. The adapter of claim 1, wherein the SBC connector is further configured so that the SBC is substantially perpendicular to the PCB when the SBC is connected to the adapter through the SBC connector.

11. The adapter of claim 1, wherein the DSD includes a solid-state memory on the PCB for non-volatilely storing data.

12. The adapter of claim 1, wherein the power input forms part of a Universal Serial Bus (USB) hub electrically connected to the DSD interface circuitry and to the SBC interface circuitry.

13. The adapter of claim 1, wherein the DSD interface circuitry includes a USB bridge.

14. The adapter of claim 1, further comprising at least one Input/Output (I/O) interface.

15. The adapter of claim 14, wherein the at least one I/O interface is electrically connected to the SBC interface circuitry such that the at least one I/O interface is configured to send data to and/or receive data from the SBC interface circuitry.

16. The adapter of claim 14, wherein the at least one I/O interface includes at least one of a High-Definition Multimedia Interface (HDMI), an Ethernet interface, a USB interface, a Liquid Crystal Display interface, a camera interface, a General Purpose Input/Output (GPIO) interface, and a Secure Digital (SD) card interface.

17. The adapter of claim 1, wherein the SBC includes at least one of a Raspberry Pi module, an Intel Edison module, an Intel Galileo module, and an Arduino module.

18. The adapter of claim 1, wherein the adapter, the DSD, and the SBC are housed together within an enclosure.

19. The adapter of claim 1, wherein the DSD includes at least one of a rotating disk and a solid-state memory for non-volatilely storing data.

20. A Data Storage Device (DSD) in communication with a Single Board Computer (SBC), the DSD comprising:
at least one memory for storing data;
a power input configured to receive power from a power source; and
SBC interface circuitry electrically connected to the power input and configured to provide power from the power input to the SBC and to send data to and receive data from the SBC for interfacing between the DSD and the SBC.

21. The DSD of claim 20, wherein the power input forms part of a Universal Serial Bus (USB) hub electrically connected to the SBC interface circuitry.

22. The DSD of claim 20, further comprising:
a controller configured to control operation of the at least one memory; and
a USB bridge configured to interface with the controller.

23. The DSD of claim 20, further comprising at least one Input/Output (I/O) interface.

24. The DSD of claim 23, wherein the at least one I/O interface is electrically connected to the SBC interface circuitry such that the at least one I/O interface is configured to send data to and/or receive data from the SBC interface circuitry.

25. The DSD of claim 23, wherein the at least one I/O interface includes at least one of a High-Definition Multimedia Interface (HDMI), an Ethernet interface, a USB interface, a Liquid Crystal Display interface, a camera interface, a General Purpose Input/Output (GPIO) interface, and a Secure Digital (SD) card interface.

26. The DSD of claim 20, wherein the SBC includes at least one of a Raspberry Pi module, an Intel Edison module, an Intel Galileo module, and an Arduino module.

27. The DSD of claim 20, wherein the DSD and SBC are housed together within an enclosure.

28. The DSD of claim 20, wherein the at least one memory includes at least one of a rotating disk and a solid-state memory for storing data.

29. An adapter for a Single Board Computer (SBC), the adapter comprising:
a Printed Circuit Board (PCB);
at least one Input/Output (I/O) interface on the PCB including a powered I/O interface configured to receive power from a power source; and
SBC interface circuitry on the PCB that is electrically connected to the at least one I/O interface and configured to send data to and receive data from the SBC for interfacing between the SBC and the at least one I/O interface, wherein the SBC interface circuitry is further configured to provide power from the powered I/O interface to the SBC; and
wherein an SBC connector of the SBC interface circuitry is configured to physically contact the SBC when the SBC is connected to the adapter through the SBC connector.

30. The adapter of claim 29, wherein the adapter and the SBC are housed together within an enclosure to form a dongle device.

31. The adapter of claim 29, wherein the SBC fits within a footprint of the PCB when the SBC is connected to the adapter through the SBC connector.

32. The adapter of claim 29, wherein the SBC connector is further configured so that the SBC is located above or below the PCB when the SBC is connected to the adapter through the SBC connector.

33. The adapter of claim 29, wherein the powered I/O interface forms part of a Universal Serial Bus (USB) hub electrically connected to the SBC interface circuitry.

34. The adapter of claim 29, wherein the at least one I/O interface includes at least one of a High-Definition Multimedia Interface (HDMI), an Ethernet interface, a USB interface, a Liquid Crystal Display interface, a camera interface, a General Purpose Input/Output (GPIO) interface, and a Secure Digital (SD) card interface.

35. The adapter of claim 29, wherein the SBC includes at least one of a Raspberry Pi module, an Intel Edison module, an Intel Galileo module, and an Arduino module.

36. The adapter of claim 29, further comprising a solid-state memory on the PCB for non-volatilely storing data.
